(19) United States
(12) Patent Application Publication
(10) Pub. No.: US 2025/0215340 A1
(43) Pub. Date: Jul. 3, 2025

(54) RAW GAS QUALITY THROUGH HEAT TRANSFER

(71) Applicant: SAUDI ARABIAN OIL COMPANY, Dhahran (SA)

(72) Inventors: Saad S. Al-Hajri, Dhahran (SA); Hani A. Al-Omair, Dhahran (SA); Majed M. Shammari, Dhahran (SA); Abdulrahman R. Bugubaia, Dhahran (SA)

(73) Assignee: SAUDI ARABIAN OIL COMPANY, Dhahran (SA)

(21) Appl. No.: 18/400,459

(22) Filed: Dec. 29, 2023

(51) Int. Cl. C10L 3/10

(52) U.S. Cl. CPC C10L 3/106; C10L 3/104; C10L 3/105

(57) ABSTRACT

A method for improving raw gas quality is disclosed. The method includes flowing a raw gas through a first pipeline from an upstream facility to a first downstream facility, flowing the raw gas through a second pipeline from the upstream facility to a second downstream facility, and injecting a dry gas in the first pipeline downstream of the upstream facility and upstream of the first downstream facility to transfer heat to the raw gas and promote fluid flow through the first pipeline. The raw gas includes a plurality of liquid contaminants, and the raw gas is at a lower temperature than the dry gas.

### BACKGROUND

The production of raw gas includes transportation of fluids between facilities for additional processing. The raw gas is generally at a lower temperature with liquid contaminants that can cause liquid accumulation in pipelines. Conventional processes to remove liquid accumulation in pipelines may utilize a scraper, a device with blades or brushes inserted in a pipeline for cleaning purposes. The pressure of a gas stream behind the scraper pushes the scraper throughout the pipeline to clean out the liquid build up. Still, using a scraper requires cleaning and maintenance for the scraper itself, and results in an inconsistent flow of raw gas through the line. Additionally, if slugs form that exceed the capacity of the slug catcher unit that receives the slug from the outlet of the pipeline, hydrocarbon liquid burning can occur.

Accordingly, there exists a need for a method to mobilize raw gas through the existing pipelines between processing facilities to improve gas production and decrease liquid build up.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for improving raw gas quality. The method includes flowing a raw gas through a first pipeline from an upstream facility to a first downstream facility, flowing the raw gas through a second pipeline from the upstream facility to a second downstream facility, and injecting a dry gas in the first pipeline downstream of the upstream facility and upstream of the first downstream facility to transfer heat to the raw gas and promote fluid flow through the first pipeline, wherein the raw gas includes a plurality of liquid contaminants, and wherein the raw gas is at a lower temperature than the dry gas.

In another aspect, embodiments disclosed herein relate to a method for improving raw gas quality. The method includes flowing a raw gas through a first pipeline from an upstream facility to a first downstream facility, flowing a raw gas through a second pipeline from a second downstream facility, flowing a vapor stream from a plurality of gas oil separation plants to connect with the first pipeline to the first downstream facility, flowing a vapor stream from the plurality of gas oil separation plants to connect with the second pipeline to the second downstream facility, injecting and controlling a flow rate of a dry gas in the first pipeline downstream of the upstream facility and upstream of the first downstream facility to transfer heat to the raw gas and promote fluid flow through the first pipeline, wherein the flow rate of the dry gas is in a range of 170 to 230 MMSCFD, and monitoring a pressure in the one or more pipelines during injecting, wherein the raw gas comprises a plurality of liquid contaminants selected from the group consisting of water, nitrogen, carbon dioxide, hydrogen sulfide, methane, ethane, propane, isobutane, butane, pentane, isopentane, hexane, heptane, octane, nonane, decane, and a hydrocarbon containing greater than ten carbon, and wherein the raw gas is at a lower temperature than the dry gas.

Other aspects and advantages of the claimed subject matter will be apparent from the following description and the appended claims.

### BRIEF DESCRIPTION OF DRAWINGS

FIG. 1 is a process flow diagram of the dry gas being injected into the raw gas pipelines in accordance with one or more embodiments.

FIG. 2 is a graph of dry gas flow rate, liquid content, and time in accordance with one or more embodiments.

FIG. 3 is a graph of pressure against temperature including an operational envelope of a mixture of dry gas and raw gas at a specified flow rate of dry gas in accordance with one or more embodiments.

### DETAILED DESCRIPTION

In one aspect, embodiments disclosed herein relate to a method for improving raw gas quality. In another aspect, embodiments disclosed herein relate to a method for improving raw gas quality by injecting a controlled flow rate of a dry gas and monitoring the pipelines during injecting.

Raw gas may be produced in an independent facility and may be directed through a pipeline to downstream facilities for further processing. Raw gas is defined as a natural combustible hydrocarbon gas containing greater than 15% of heavy hydrocarbons. Raw gas is produced from a well and is unprocessed, containing natural gas liquid contaminants such as water, nitrogen, carbon dioxide, hydrogen sulfide, methane, ethane, propane, isobutane, butane, pentane, isopentane, hexane, heptane, octane, nonane, decane, and a hydrocarbon containing greater than ten carbon.

Raw gas from independent facilities may be directed through a pipeline to downstream facilities for further processing. In some embodiments, one or more facilities may be an oil processing unit and a natural gas liquids (NGL) facility. The off-gases from the oil processing unit are sent to the NGL facility for processing, then produced to other facilities. Such other facilities may be gas facilities. The treatment in the gas facility consists of separating the off-gases from oil processing into one or more components, such as, but not limited to, methane, ethane, propane and butane.

When raw gas flows downstream for further processing, it may flow slowly and leave liquid blockages because of the cool temperature and levels of liquid contaminants. Dry gas may be injected into the pipeline at higher temperatures than the raw gas to help mobilize the raw gas and prevent liquid blockages by increasing the overall flow rate and pressure in the pipeline while also using heat to increase fluidity.

Dry gas is mostly methane, containing negligible amounts of dissolved liquid hydrocarbons and impurities. The higher the methane concentration, the drier the natural gas. In some embodiments, the methane concentration of the dry gas is in the range of 80 mol % to 85 mol %.

The flow rate of dry gas injected impacts the effectiveness of the injection. In order to properly monitor the process for adequate injection, pressure sensors may be located throughout the system for continuous monitoring. There may be a pressure sensor in the pipeline upstream of the injector and downstream of the injector. An acceptable range of pressure readings for the first pressure sensor may be in the range of 220 to 850 psi. An acceptable range of pressure readings for the second pressure sensor may be in the range of 220 to 850 psi.

In some embodiments, the produced raw gas may flow to multiple downstream processing facilities. In these embodiments, the dry gas may be injected into a pipeline to the downstream facilities. In other embodiments, there may be a single dry gas injection point before the pipeline splits into multiple pathways to multiple facilities. The flow rate of dry gas may be in the range of 170 to 230 million standard cubic feet per day (MMSCFD).

The downstream facilities may process the raw gas to recover ethane. By diverting a portion of the raw gas to two different processing facilities, the velocity in the pipelines can be optimized, thus maximizing ethane recovery from downstream facilities. For a constant pipe diameter, the velocity in the pipelines increases as the mass flow rate increases. The increased mass flow rate, which occurs when the raw gas is diverted to multiple facilities, also helps to continuously sweep the pipeline and mitigate liquid stagnation.

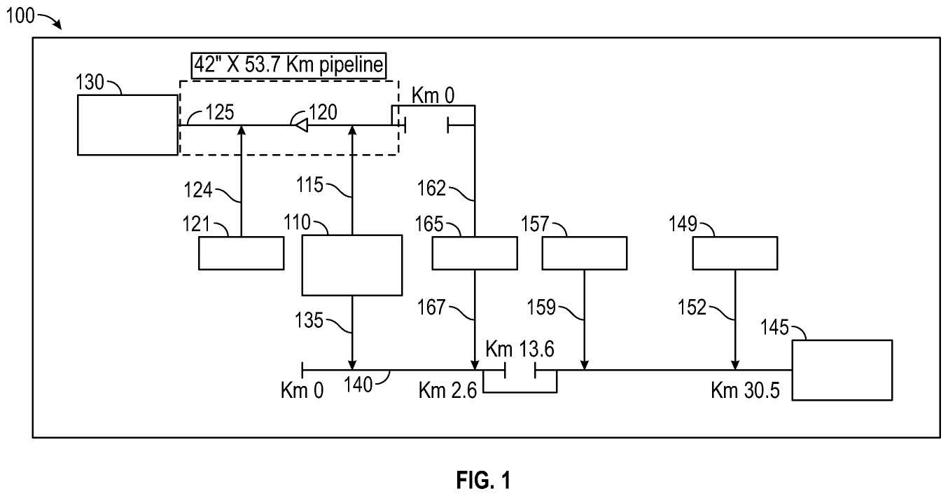

Turning now to the figures, FIG. 1 is a process flow diagram for one example of the process for injecting dry gas into a raw gas pipeline. In FIG. 1, the raw gas is produced in Facility A, which is the upstream facility 110. The raw gas flows through a first pipeline 115 from the upstream Facility A 110 to a first downstream facility 130, Facility B. Then, the raw gas flows through a second pipeline 135 to a second downstream facility 145, Facility C. The dry gas is injected at an injection point 120 to transfer heat to the raw gas and promote fluid flow through the pipeline. There is a plurality of gas oil separation plants (GOSP) that separate fluids into vapor and liquid components. While illustrated with four GOSPs, the envisioned system could include fewer than four or more than four GOSPs.

In one or more embodiments, a first gas oil separation plant 121 provides a vapor stream 124 to the pipeline 125 leading to the first downstream facility 130, Facility B. The vapor in the pipeline 125 is at a temperature in the range of 85 to 100° C. and a pressure in the range of 260 to 280 psi.

In one or more embodiments, a second gas oil separation plant 165 provides two streams: a vapor stream 162 to the first downstream facility 130, Facility B, and another vapor stream 167 to the second downstream facility 145, Facility C. The vapor streams 162 and 167 are at a temperature in the range of 145 to 160° C. and a pressure in the range of 390 to 410 psi.

In one or more embodiments, a third gas oil separation plant 157 provides a vapor stream 159 to the second downstream facility 145, Facility C. The vapor stream 159 is at a temperature in the range of 85 to 100° C. and a pressure in the range of 380 to 400 psi.

In one or more embodiments, a fourth gas oil separation plant 149 provides a vapor stream 152 to the second downstream facility 145, Facility C. The vapor stream 152 is at a temperature in the range of 85 to 100° C. and a pressure in the range of 380 to 395 psi. The raw gas flows from the upstream facility 110, Facility A, to the second downstream facility 145, Facility C, through a pipeline 135. The raw gas in the pipeline 135 is at a temperature in the range of 90 to 100° C. and a pressure in the range of 380 to 395 psi.

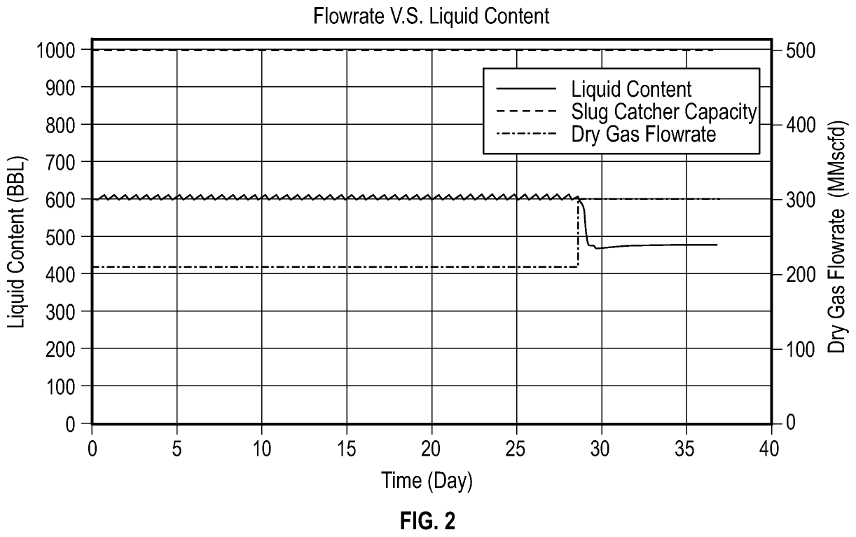

FIG. 2 is a graph of dry gas flow rate (MMSCFD), liquid content (BBL), and time (days). A slug catcher unit located within a facility receives a slug of liquid from the outlet of the pipeline. The slug catcher has a capacity of 1000 BBL. As discussed, in order to avoid hydrocarbon liquid burning, the liquid content through the pipeline should remain under the slug catcher capacity. FIG. 2 demonstrates that, at a dry gas injection flow rate of 425 MMSCFD, the liquid content stabilizes at 600 BBL, significantly below the slug catcher capacity, indicating that this flow rate of dry gas is manageable for the system capacity.

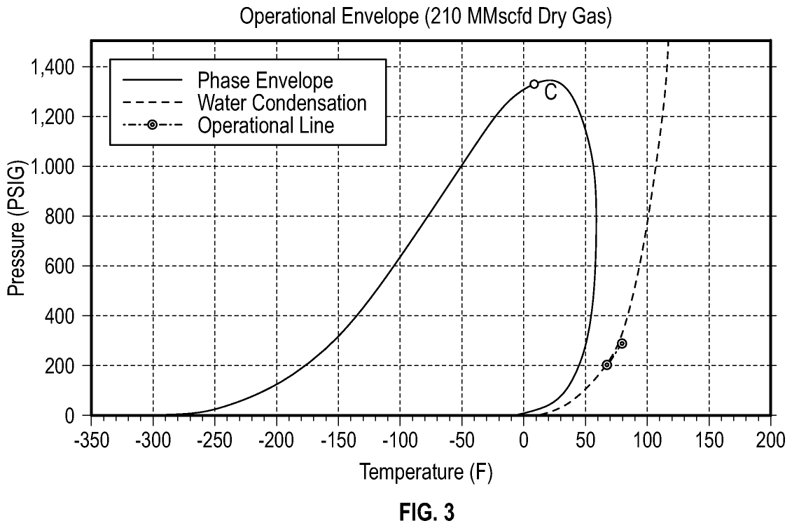

FIG. 3 is a graph of pressure (psig) against temperature (° F.) at a specified flow rate of dry gas (210 MMSCFD). The graph indicates the phase envelope for the mixture of raw gas and dry gas. The phase envelope shows that the pressure when injecting 210 MMSCFD of dry gas reaches approximately 1350 psig at approximately 25° F. Below this pressure, the mixture contains both liquid and gas. As seen, at temperatures above-10° F. and pressures between 0 to 1350 psig, the region to the right of the phase envelope is where the mixture is in a vapor phase. At temperatures between-273 and 20° F. and pressures between 0 and 1350 psig, the region to the left of the phase envelope is a liquid. The phase envelope shown in the graph of FIG. 3 may be used to determine the bubble point and the dew point of the mixture of gas. The water condensation line in FIG. 3 is called the water dew point line. The water condensation line separates the graph into two regions. To the right of the water condensation line, any water present in the mixture of gases is in a gaseous phase. To the left of the water condensation line, any water present in the mixture of gases is in a liquid phase. The operational line shown in FIG. 3 is in a region which contains gaseous water and gaseous hydrocarbons, avoiding the condensation regions.

### Example

A simulation study was completed based on the capacities of Facilities B and C receiving gas from Facility A. The feeds titled “X- #” represent the vapor streams directed to Facility B for different runs of the simulation. The feeds titled “Y” #” represent the vapor streams directed to Facility C for different runs of the simulation.

Table 1 shows the flow rate of raw gas only to Facility B. X-10 on Table 1 represents the total vapor amount from multiple sources transferred to Facility B. Table 2 shows the flow rate of raw gas only to Facility C. Y-7 on Table 2 represents the total vapor amount from multiple sources transferred to Facility C.

TABLE 1
Flow Rates (MMSCFD) to Facility B

| | OC- | NO- | DE- | 1st | 2nd | 3rd | 4rd | 1st | 2nd | 3rd | 4th | 1st | 2nd | 3rd | 4rd | 1st | 2nd |
|---|---|---|---|---|---|---|---|---|---|---|---|---|---|---|---|---|---|
| | TOBER, | VEMBER, | CEMBER, | QRT | QRT | QRT | QRT | QRT | QRT | QRT | QRT | QRT | QRT | QRT | QRT | QRT | QRT |
| Feed | 2020 | 2020 | 2020 | 2021 | 2021 | 2021 | 2021 | 2022 | 2022 | 2022 | 2022 | 2023 | 2023 | 2023 | 2023 | 2024 | 2024 |
| X-1 | 164 | 162 | 160 | 165 | 168 | 169 | 166 | 166 | 169 | 170 | 167 | 102 | 129 | 130 | 127 | 109 | 111 |
| X-2 | 189 | 184 | 179 | 185 | 193 | 195 | 188 | 189 | 195 | 196 | 190 | 145 | 150 | 151 | 146 | 126 | 130 |
| X-3 | 62 | 53 | 117 | 205 | 35 | 36 | 72 | 115 | 35 | 36 | 32 | 121 | 142 | 146 | 32 | 32 | 41 |
| X-4 | 173 | 174 | 133 | 133 | 172 | 173 | 133 | 134 | 175 | 175 | 180 | 166 | 156 | 156 | 163 | 148 | 138 |
| X-5 | 0 | 0 | 0 | 0 | 0 | 0 | 0 | 0 | 0 | 0 | 0 | 0 | 0 | 0 | 0 | 0 | 0 |
| X-6 | 238 | 238 | 238 | 259 | 259 | 259 | 259 | 270 | 270 | 270 | 270 | 292 | 292 | 292 | 292 | 303 | 303 |
| X-7 | 28 | 27 | 0 | 0 | 28 | 28 | 27 | 26 | 28 | 28 | 27 | 27 | 28 | 28 | 27 | 27 | 28 |
| X-8 | 699 | 47 | 0 | 527 | 670 | 400 | 607 | 165 | 571 | 318 | 270 | 349 | 635 | 635 | 635 | 654 | 670 |
| X-9 | 0 | 0 | 0 | 0 | 0 | 0 | 0 | 0 | 0 | 0 | 0 | 0 | 0 | 0 | 0 | 0 | 0 |
| X-10 | 1553 | 884 | 827 | 1475 | 1526 | 1260 | 1452 | 1066 | 1444 | 1193 | 1136 | 1202 | 1531 | 1537 | 1423 | 1399 | 1421 |

TABLE 2
Flow Rates (MMSCFD) to Facility C

| | OC- | NO- | DE- | 1st | 2nd | 3rd | 4rd | 1st | 2nd | 3rd | 4th | 1st | 2nd | 3rd | 4rd | 1st | 2nd |
|---|---|---|---|---|---|---|---|---|---|---|---|---|---|---|---|---|---|
| | TOBER, | VEMBER, | CEMBER, | QRT | QRT | QRT | QRT | QRT | QRT | QRT | QRT | QRT | QRT | QRT | QRT | QRT | QRT |
| Feed | 2020 | 2020 | 2020 | 2021 | 2021 | 2021 | 2021 | 2022 | 2022 | 2022 | 2022 | 2023 | 2023 | 2023 | 2023 | 2024 | 2024 |
| Y-1 | 0 | 0 | 0 | 0 | 0 | 0 | 0 | 0 | 0 | 0 | 0 | 0 | 0 | 0 | 0 | 0 | 0 |
| Y-2 | 189 | 191 | 121 | 39 | 216 | 216 | 173 | 129 | 216 | 216 | 212 | 123 | 110 | 106 | 212 | 212 | 211 |
| Y-3 | 100 | 100 | 150 | 150 | 105 | 104 | 150 | 150 | 104 | 104 | 110 | 100 | 100 | 100 | 102 | 102 | 100 |
| Y-4 | 358 | 356 | 355 | 323 | 325 | 326 | 323 | 323 | 325 | 326 | 323 | 290 | 292 | 293 | 290 | 290 | 292 |
| Y-5 | 0 | 0 | 0 | 0 | 0 | 0 | 0 | 44 | 0 | 0 | 0 | 92 | 102 | 104 | 0 | 0 | 0 |
| Y-6 | 43 | 43 | 43 | 40 | 43 | 44 | 44 | 44 | 44 | 44 | 44 | 45 | 45 | 45 | 44 | 45 | 46 |
| Y-7 | 690 | 690 | 669 | 552 | 690 | 690 | 690 | 690 | 690 | 690 | 690 | 649 | 649 | 649 | 649 | 649 | 649 |

Table 3 shows the flow rate of the raw gas to Facility B following a redistribution of the gas exiting Facility A. This trial specifically involved redirecting an amount of the raw gas from going only to Facility B to then to Facility C and share the load between Facility B and Facility C to optimize overall ethane recovery and maximize flow velocity through the pipelines. X-9 on Table 3 represents the total vapor amount from multiple sources transferred to Facility B. The X-10 value from Table 3 is lower than the X-10 value from Table 1 because the values for Table 3 correspond to the case with redistribution of gas.

TABLE 3
Flow Rates (MMSCFD) to Facility B following Facility A Gas Redistribution

| | OC- | NO- | DE- | 1st | 2nd | 3rd | 4rd | 1st | 2nd | 3rd | 4th | 1st | 2nd | 3rd | 4rd | 1st | 2nd |
|---|---|---|---|---|---|---|---|---|---|---|---|---|---|---|---|---|---|
| | TOBER, | VEMBER, | CEMBER, | QRT | QRT | QRT | QRT | QRT | QRT | QRT | QRT | QRT | QRT | QRT | QRT | QRT | QRT |
| Feed | 2020 | 2020 | 2020 | 2021 | 2021 | 2021 | 2021 | 2022 | 2022 | 2022 | 2022 | 2023 | 2023 | 2023 | 2023 | 2024 | 2024 |
| X-1 | 164 | 162 | 160 | 165 | 168 | 169 | 166 | 166 | 169 | 170 | 167 | 102 | 129 | 130 | 127 | 109 | 111 |
| X-2 | 189 | 184 | 179 | 185 | 193 | 195 | 188 | 189 | 195 | 196 | 190 | 145 | 150 | 151 | 146 | 126 | 130 |
| X-3 | 42 | 35 | 35 | 35 | 81 | 82 | 81 | 45 | 81 | 82 | 35 | 60 | 61 | 64 | 35 | 35 | 49 |
| X-4 | 123 | 124 | 133 | 133 | 127 | 127 | 133 | 134 | 130 | 129 | 140 | 116 | 256 | 256 | 115 | 100 | 88 |
| X-5 | 0 | 0 | 0 | 0 | 0 | 0 | 0 | 0 | 0 | 0 | 0 | 0 | 0 | 0 | 0 | 0 | 0 |
| X-6 | 238 | 238 | 238 | 259 | 259 | 259 | 259 | 270 | 270 | 270 | 270 | 292 | 292 | 292 | 292 | 303 | 303 |
| X-7 | 28 | 27 | 0 | 0 | 28 | 28 | 27 | 26 | 28 | 28 | 27 | 27 | 28 | 28 | 27 | 27 | 28 |
| X-8 | 699 | 47 | 0 | 527 | 670 | 400 | 607 | 165 | 571 | 318 | 270 | 349 | 635 | 635 | 635 | 654 | 670 |
| X-9 | 0 | 0 | 0 | 0 | 0 | 0 | 0 | 0 | 0 | 0 | 0 | 0 | 0 | 0 | 0 | 0 | 0 |
| X-10 | 1482 | 816 | 745 | 1305 | 1527 | 1260 | 1461 | 996 | 1444 | 1193 | 1098 | 1091 | 1551 | 1555 | 1377 | 1354 | 1379 |

Table 4 shows the flow rate of the raw gas to Facility C following a redistribution of the gas exiting Facility A. This trial specifically involved redirecting an amount of the raw gas from going only to Facility C to then to Facility B and share the load between Facility B and Facility C to optimize overall ethane recovery and maximize flow velocity through the pipelines. Y-7 on Table 4 represents the total vapor amount from multiple sources transferred to Facility C. The Y-7 value from Table 4 is higher than the Y-7 value from Table 2.

TABLE 4
Flow Rates (MMSCFD) to Facility C following Facility A Gas Redistribution

| | OC- | NO- | DE- | 1st | 2nd | 3rd | 4rd | 1st | 2nd | 3rd | 4th | 1st | 2nd | 3rd | 4rd | 1st | 2nd |
|---|---|---|---|---|---|---|---|---|---|---|---|---|---|---|---|---|---|
| | TOBER, | VEMBER, | CEMBER, | QRT | QRT | QRT | QRT | QRT | QRT | QRT | QRT | QRT | QRT | QRT | QRT | QRT | QRT |
| Feed | 2020 | 2020 | 2020 | 2021 | 2021 | 2021 | 2021 | 2022 | 2022 | 2022 | 2022 | 2023 | 2023 | 2023 | 2023 | 2024 | 2024 |
| Y-1 | 0 | 0 | 0 | 0 | 0 | 0 | 0 | 0 | 0 | 0 | 0 | 0 | 0 | 0 | 0 | 0 | 0 |
| Y-2 | 359 | 359 | 353 | 359 | 321 | 320 | 360 | 349 | 321 | 320 | 360 | 334 | 217 | 217 | 360 | 359 | 352 |
| Y-3 | 90 | 90 | 90 | 90 | 90 | 90 | 90 | 90 | 90 | 90 | 90 | 90 | 90 | 90 | 90 | 90 | 90 |
| Y-4 | 358 | 356 | 355 | 323 | 325 | 326 | 323 | 323 | 325 | 326 | 323 | 290 | 292 | 293 | 290 | 290 | 292 |
| Y-5 | 0 | 0 | 0 | 0 | 0 | 0 | 0 | 44 | 0 | 0 | 0 | 92 | 102 | 104 | 0 | 0 | 0 |
| Y-6 | 43 | 43 | 43 | 40 | 43 | 44 | 44 | 44 | 44 | 44 | 44 | 45 | 45 | 45 | 44 | 45 | 46 |
| Y-7 | 850 | 848 | 841 | 812 | 780 | 779 | 817 | 850 | 780 | 780 | 817 | 850 | 746 | 749 | 784 | 784 | 780 |

Table 5 shows the composition of the feed gas to Facility B, containing a variety of compounds including water, nitrogen, carbon dioxide, hydrogen sulfide, methane, ethane, propane, isobutane, butane, pentane, isopentane, hexane, heptane, octane, nonane, decane, and a hydrocarbon containing greater than ten carbon.

TABLE 5
Facility B Feed Gas Compositions

| | X-1 | X-2 | X-3 | X-4 | X-5 | X-6 | X-7 | X-8 |
|---|---|---|---|---|---|---|---|---|
| Component | Mol % | | | | | | | |
| H2O | 0 | 0 | 0 | 0 | 0.07 | 1.28 | 0.71 | 0 |
| N2 | 0.435 | 0.31 | 0.88 | 8.75 | 0.24 | 0.57 | 0.52 | 6.34 |
| CO2 | 12 | 11.78 | 9.05 | 3.82 | 6.59 | 8.21 | 8.66 | 0 |
| H2S | 2.72 | 2.19 | 3.75 | 1.63 | 4.09 | 2.56 | 3.37 | 0 |
| C1 | 50.7 | 52.15 | 43.19 | 71.29 | 12.89 | 58.1 | 57.78 | 90.54 |
| C2 | 17.26 | 17.4 | 23.74 | 10.31 | 33.52 | 15.96 | 16.79 | 2.82 |
| C3 | 10.89 | 10.68 | 14.86 | 2.5 | 29.17 | 8.38 | 8.06 | 0.3 |
| iC4 | 1.02 | 0.95 | 1 | 0.51 | 3.23 | 0.77 | 0.7 | 0 |
| nC4 | 3.43 | 3.29 | 2.72 | 0.77 | 7.61 | 2.35 | 2.16 | 0 |
| iC5 | 0.496 | 0.325 | 0.23 | 0.17 | 1.08 | 0.44 | 0.37 | 0 |
| nC5 | 0.58 | 0.52 | 0.32 | 0.16 | 1.16 | 0.61 | 0.47 | 0 |
| C6 | 0.5 | 0.41 | 0.1 | 0.11 | 0.28 | 0.43 | 0.19 | 0 |
| C7 | 0 | 0 | 0 | 0 | 0.05 | 0.18 | 0.14 | 0 |
| C8 | 0 | 0 | 0 | 0 | 0.01 | 0.09 | 0.07 | 0 |
| C9 | 0 | 0 | 0 | 0 | 0 | 0.04 | 0.02 | 0 |
| C10+ | 0 | 0 | 0 | 0 | 0 | 0.02 | 0 | 0 |
| TOTAL | 100 | 100 | 100 | 100 | 100 | 100 | 100 | 100 |

Table 6 shows the flow rate of the raw gas to Facility B following a redistribution of the gas exiting Facility A and the injection of the dry gas. X-14 on Table 6 represents the total vapor amount from multiple sources transferred to Facility B. This value includes the injection of dry gas represented by X-13 on Table A-6. This trial specifically involved redirecting an amount of the raw gas from going only to Facility B to then go to Facility C and share the load, in addition to the injection of dry gas in the pipeline, in order to optimize overall ethane recovery and maximize flow velocity through the pipelines.

TABLE 6
Flow Rates (MMSCFD) to Facility B following Facility A Gas Redistribution and Dry Gas Injection

| | OC- | NO- | DE- | 1st | 2nd | 3rd | 4rd | 1st | 2nd | 3rd | 4th | 1st | 2nd | 3rd | 4rd | 1st | 2nd |
|---|---|---|---|---|---|---|---|---|---|---|---|---|---|---|---|---|---|
| | TOBER, | VEMBER, | CEMBER, | QRT | QRT | QRT | QRT | QRT | QRT | QRT | QRT | QRT | QRT | QRT | QRT | QRT | QRT |
| Feed | 2020 | 2020 | 2020 | 2021 | 2021 | 2021 | 2021 | 2022 | 2022 | 2022 | 2022 | 2023 | 2023 | 2023 | 2023 | 2024 | 2024 |
| X-1 | 164 | 162 | 160 | 165 | 168 | 169 | 166 | 166 | 169 | 170 | 167 | 102 | 129 | 130 | 127 | 109 | 111 |
| X-2 | 189 | 184 | 179 | 185 | 193 | 195 | 188 | 189 | 195 | 196 | 190 | 145 | 150 | 151 | 146 | 126 | 130 |
| X-3 | 42 | 35 | 35 | 35 | 81 | 82 | 00 | 45 | 81 | 82 | 35 | 60 | 61 | 64 | 35 | 35 | 49 |
| X-4 | 123 | 124 | 133 | 133 | 127 | 127 | 133 | 134 | 130 | 129 | 140 | 116 | 256 | 256 | 115 | 100 | 88 |
| X-5 | 0 | 0 | 0 | 0 | 0 | 0 | 0 | 0 | 0 | 0 | 0 | 0 | 0 | 0 | 0 | 0 | 0 |
| X-6 | 238 | 238 | 238 | 259 | 259 | 259 | 259 | 270 | 270 | 270 | 270 | 292 | 292 | 292 | 292 | 303 | 303 |
| X-7 | 28 | 27 | 0 | 0 | 28 | 28 | 27 | 26 | 28 | 28 | 27 | 27 | 28 | 28 | 27 | 27 | 28 |
| X-8 | 699 | 47 | 0 | 527 | 670 | 400 | 607 | 165 | 571 | 318 | 270 | 349 | 635 | 635 | 635 | 654 | 670 |
| X-9 | 0 | 0 | 0 | 0 | 0 | 0 | 0 | 0 | 0 | 0 | 0 | 0 | 0 | 0 | 0 | 0 | 0 |
| X-10 | 1482 | 816 | 745 | 1305 | 1527 | 1260 | 1461 | 996 | 1444 | 1193 | 1098 | 1091 | 1551 | 1555 | 1377 | 1354 | 1379 |
| X-11 | 1850 | 1850 | 1850 | 1850 | 1850 | 1850 | 1850 | 1850 | 1850 | 1850 | 1850 | 1850 | 1850 | 1850 | 1850 | 1850 | 1850 |
| X-12 | 368 | 1034 | 1105 | 545 | 323 | 590 | 389 | 854 | 406 | 657 | 752 | 759 | 299 | 295 | 473 | 496 | 471 |
| X-13 | 200 | 200 | 200 | 200 | 200 | 200 | 200 | 200 | 200 | 200 | 200 | 200 | 200 | 200 | 200 | 200 | 200 |
| X-14 | 1682 | 1016 | 945 | 1505 | 1727 | 1460 | 1661 | 1196 | 1644 | 1393 | 1298 | 1291 | 1751 | 1755 | 1577 | 1554 | 1579 |

Embodiments of the present disclosure may provide at least one of the following advantages. The addition of the dry gas at a higher temperature than the raw gas ensures that the raw gas moves more fluidly through the pipelines, preventing liquid blockages. By improving flow of the raw gas, additional raw gas may be transported effectively, ultimately improving ethane production.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for improving raw gas quality, the method comprising:
flowing a raw gas through a first pipeline from an upstream facility to a first downstream facility;
flowing the raw gas through a second pipeline from the upstream facility to a second downstream facility; and
injecting a dry gas in the first pipeline downstream of the upstream facility and upstream of the first downstream facility to transfer heat to the raw gas and promote fluid flow through the first pipeline,
wherein the raw gas comprises a plurality of liquid contaminants, and
wherein the raw gas is at a lower temperature than the dry gas.

2. The method of claim 1, wherein the plurality of liquid contaminants is selected from a group consisting of water, nitrogen, carbon dioxide, hydrogen sulfide, methane, ethane, propane, isobutane, butane, pentane, isopentane, hexane, heptane, octane, nonane, decane, and a hydrocarbon containing greater than ten carbon.

3. The method of claim 1, wherein the injecting further comprises controlling a flow rate of the dry gas in the first pipeline.

4. The method of claim 3, wherein controlling the flow rate of the dry gas further comprises monitoring a pressure in the first pipeline.

5. The method of claim 3, wherein the flow rate of the dry gas injected in the first pipeline to the first downstream facility is in a range of 170 to 230 MMSCFD.

6. The method of claim 1, further comprising a plurality of gas oil separation plants configured to provide vapor to the first pipeline to the first downstream facility.

7. The method of claim 1, further comprising a plurality of gas oil separation plants configured to provide vapor to the second pipeline to the second downstream facility.

8. A method for improving raw gas quality, the method comprising:
flowing a raw gas through a first pipeline from an upstream facility to a first downstream facility;
flowing a raw gas through a second pipeline from a second downstream facility;
flowing a vapor stream from a plurality of gas oil separation plants to connect with the first pipeline to the first downstream facility;
flowing a vapor stream from the plurality of gas oil separation plants to connect with the second pipeline to the second downstream facility;
injecting and controlling a flow rate of a dry gas in the first pipeline downstream of the upstream facility and upstream of the first downstream facility to transfer heat to the raw gas and promote fluid flow through the first pipeline, wherein the flow rate of the dry gas is in a range of 170 to 230 MMSCFD; and
monitoring a pressure in the one or more pipelines during injecting;
wherein the raw gas comprises a plurality of liquid contaminants selected from the group consisting of water, nitrogen, carbon dioxide, hydrogen sulfide, methane, ethane, propane, isobutane, butane, pentane, isopentane, hexane, heptane, octane, nonane, decane, and a hydrocarbon containing greater than ten carbon;
wherein the raw gas is at a lower temperature than the dry gas.
